(19) United States
(12) Patent Application Publication
(10) Pub. No.: US 2019/0177465 A1
(43) Pub. Date: Jun. 13, 2019

(54) POLYOL PRE-MIXES HAVING IMPROVED SHELF LIFE

(71) Applicant: Arkema Inc., King of Prussia, PA (US)

(72) Inventors: Benjamin Bin CHEN, Wayne, PA (US); Joseph S. COSTA, Gilbertsville, PA (US); Laurent T. ABBAS, Ardmore, PA (US); Sri R. SESHADRI, Holland, PA (US)

(21) Appl. No.: 16/321,052

(22) PCT Filed: Jul. 20, 2017
(86) PCT No.: PCT/US2017/043069

§ 371 Date: Jan. 28, 2019

Related U.S. Application Data
(60) Provisional application No. 62/368,409, filed on Jul. 29, 2016.

(51) Int. Cl. C08G 18/32; C08G 18/40; C08G 18/48; C08G 18/76

(52) U.S. Cl. CPC C08G 18/3206; C08G 18/3218; C08G 2101/0025; C08G 18/4816; C08G 18/7664; C08G 18/4018

(57) ABSTRACT

Incorporating a cycloaliphatic epoxide such as cyclohexene oxide into a polyol pre-mix containing an amine catalyst and a halogenated hydroolefin blowing agent such as HCFO-1233zd helps to improve the storage-stability of the pre-mix and to ensure that a thermoset foam prepared therefrom is of satisfactory quality.

### FIELD OF THE INVENTION

The present invention relates to a method of improving the shelf life of polyol pre-mixes that contain halogenated hydroolefin blowing agents, including hydrochlorofluoroolefin blowing agents such as HCFO-1233zd, and/or improving the quality of the thermoset foams prepared from such polyol pre-mixes.

### BACKGROUND OF THE INVENTION

The Montreal Protocol for the protection of the ozone layer mandated the phase out of the use of chlorofluorocarbons (CFCs). Materials more “friendly” to the ozone layer, such as hydrofluorocarbons (HFCs), e.g., HFC-134a, replaced chlorofluorocarbons. The latter compounds have proven to be greenhouse gases, causing global warming and are subject to reduction that is coordinated by the United Nations Framework Convention on Climate Change (UNFCCC). The emerging replacement materials, halogenated olefins, were shown to be environmentally acceptable as they have zero ozone depletion potential (ODP) and acceptable low global warming potential (GWP).

Currently used blowing agents for thermoset foams include HFC-134a, HFC-245fa, HFC-365mfc (that have relatively high global warming potential) and hydrocarbons such as pentane isomers (that are flammable and have low energy efficiency). Therefore, new alternative blowing agents are being sought. Halogenated hydroolefinic materials such as hydrofluoropropenes and/or hydrochlorofluoropropenes have generated interest as replacements for HFCs. The inherent chemical instability of these materials in the lower atmosphere provides for a low global warming potential and zero or near zero ozone depletion properties desired.

However, the preparation of satisfactory thermoset foams using such halogenated hydroolefinic materials as blowing agents can be challenging, due to certain shelf-life issues. In commercial practice, blowing agents typically are combined with polyols and possibly other components such as surfactant and catalyst to form so-called “B-side” pre-mixes that are then stored for several days to several weeks prior to being combined with an “A-side” component containing a reactant such as polyisocyanate that is capable of reacting with the polyol to form a thermoset foam. Ideally, the characteristics of the thermoset foam thereby obtained should not be significantly affected by the length of time the polyol pre-mix has aged prior to such use. However, as disclosed by US 2009/0099272 A1, “A shortcoming of two-component systems, especially those using certain hydrohaloolefins, including, HFO-1234ze and HFCO-1233zd is the shelf-life of the B-side composition. Normally when a foam is produced by bringing together the A and B component, a good foam is obtained. However, if the polyol premix composition is aged, prior to treatment with the polyisocyanate, the foam are of lower quality and may even collapse during the formation of foam”.

### SUMMARY OF THE INVENTION

It was unexpectedly discovered that incorporating certain types of cycloaliphatic epoxides in a polyol pre-mix intended to be stored for some period of time, prior to being combined with a polyisocyanate or other reactant to form a thermoset foam, improves the shelf-life of the pre-mix and/or the quality of the thermoset foams obtainable therefrom upon reaction with polyisocyanate or other such reactant.

Various aspects of the present invention may be summarized as follows:

Aspect 1: A polyol pre-mix comprising:
a) at least one blowing agent, including at least one halogenated hydroolefin blowing agent;
b) at least one polyol;
c) at least one amine catalyst; and
d) at least one cycloaliphatic epoxide which contains at least one epoxy group consisting of an oxygen atom and two carbon atoms which are part of an aliphatic ring.

Aspect 2: The polyol pre-mix of Aspect 1, wherein the at least one cycloaliphatic epoxide is essentially non-reactive with the at least one amine catalyst in the polyol pre-mix at 25° C. for a period of at least 6 months. According to this aspect, no products resulting from the reaction of the cycloaliphatic epoxide with the amine catalyst can be detected by ¹H NMR analysis in the polyol pre-mix after storing the polyol pre-mix for 6 months at 25° C. Alternatively, less than 10% or less than 5% loss of the cycloaliphatic epoxide takes place due to reaction with the at least one amine catalyst when the polyol pre-mix is stored for 6 months at 25° C.

Aspect 3: The polyol pre-mix of Aspect 1 or 2, wherein a substituent other than hydrogen is bonded to one of the two carbon atoms which are part of the aliphatic ring.

Aspect 4: The polyol pre-mix of Aspect 1 or 2, wherein neither of the carbon atoms which are part of the aliphatic ring is substituted with a substituent other than hydrogen.

Aspect 5: The polyol pre-mix of any of Aspects 1-4, wherein the at least one halogenated hydroolefin blowing agent is selected from the group consisting of hydrofluoroolefins, hydrochlorofluoroolefins, and combinations thereof.

Aspect 6: The polyol pre-mix of any of Aspects 1-5, wherein the at least one halogenated olefin blowing agent includes HFCO-1233zd.

Aspect 7: The polyol pre-mix of any of Aspects 1-6, additionally comprising at least one surfactant.

Aspect 8: The polyol pre-mix of any of Aspects 1-7, comprising at least one amine catalyst selected from the group consisting of tertiary amines.

Aspect 9: The polyol premix of any of Aspects 1-8, comprising from about 0.1 to about 5% by weight amine catalyst.

Aspect 10: The polyol pre-mix of any of Aspects 1-9, wherein the aliphatic ring is a five- to eight-membered ring.

Aspect 11: The polyol pre-mix of any of Aspects 1-10, wherein the at least one cycloaliphatic epoxide includes at least one cycloaliphatic epoxide selected from the group consisting of cyclopentene oxide, cyclohexene oxide, cycloheptene oxide, cyclooctene oxide, norbornene oxide, terpineol oxide, alpha-ionone oxide, limonene oxide, terpinene oxide, alpha-pinene oxide, menthadiene oxide, dicyclopentadiene oxide, and dicyclopentadiene dioxide.

Aspect 12: The polyol pre-mix of any of Aspects 1-11, wherein the polyol pre-mix is comprised of from about 0.2 wt % to about 7 wt % cycloaliphatic epoxide.

Aspect 13: The polyol pre-mix of any of Aspects 1-12, wherein the polyol pre-mix is comprised of from about 0.5 wt % to about 2 wt % cycloaliphatic epoxide.

Aspect 14: The polyol pre-mix of any of Aspects 1-13, wherein the at least one polyol includes at least one polyester polyol.

Aspect 15: The polyol premix of any of Aspects 1-14, wherein the at least one polyol includes at least one polyester polyol and at least one polyether polyol.

Aspect 16: The polyol premix of Aspect 15, wherein the at least one polyether polyol includes at least one polyether polyol selected from the group consisting of propoxylated glycerin polyether polyols, propoxylated sucrose polyether polyols, propoxylated sorbitol polyether polyols, propoxylated amine polyether polyols, propoxylated Mannich polyether polyols, and combinations thereof.

Aspect 17: The polyol pre-mix of any of Aspects 14-16, wherein the at least one polyester polyol includes at least one aromatic polyester polyol.

Aspect 18: The polyol pre-mix of any of Aspects 1-17, wherein the at least one polyol includes at least one polyether polyol having a functionality of 3 or more.

Aspect 19: A method of making a thermoset foam, comprising combining a polyol pre-mix in accordance with any of Aspects 1-18 with at least one substance reactive with the at least one polyol.

Aspect 20: The method of Aspect 19, wherein the at least one substance reactive with the at least one polyol includes at least one polyisocyanate.

Aspect 21: A method of stabilizing a polyol pre-mix comprised of at least one polyol, at least one amine catalyst and at least one halogenated hydroolefin blowing agent, wherein the method comprises incorporating into the polyol pre-mix at least one cycloaliphatic epoxide which contains at least one epoxy group consisting of an oxygen atom and two carbon atoms which are part of an aliphatic ring.

### BRIEF DESCRIPTION OF THE DRAWINGS

FIG. 1 shows the foams obtained in Comparative Examples 1 and 2.

FIG. 2 shows an ¹H NMR analysis of the formulation of Example 1 (no cyclohexene oxide present).

FIG. 3 shows an ¹H NMR analysis of the formulation of Example 2 (cyclohexene oxide present).

### DETAILED DESCRIPTION OF THE INVENTION

The present invention relates to polyol pre-mixes which have improved shelf life. That is, the pre-mixes, which contain polyol(s), amine catalyst(s) and halogenated olefin blowing agent(s), are capable of being stored at ambient conditions for extended periods of time without significant changes in their performance when used to prepare thermoset foams. Further, the pre-mixes are capable of producing thermoset foams having a reduced propensity to collapse during foaming.

The blowing agent in the pre-mixes of the present invention comprises one or more halogenated hydroolefins such as hydrofluoroolefins (HFOs) and/or hydrochlorofluoroolefins (HCFOs), optionally in combination with one or more other types of blowing agents such as hydrofluorocarbons (HFCs), hydrofluoroethers (HFEs), hydrocarbons, alcohols, aldehydes, ketones, ethers/diethers or carbon dioxide.

Thus, in one embodiment, the blowing agent in the pre-mix of the present invention is a hydrofluoroolefin or a hydrochlorofluoroolefin, alone or in a combination. Preferred hydrofluoroolefin (HFO) blowing agents contain 3, 4, 5, or 6 carbons, and include but are not limited to pentafluoropropanes such as 1,2,3,3,3-pentafluoropropene (HFO 1225ye); tetrafluoropropenes such as 1,3,3,3-tetrafluoropropene (HFO 1234ze, E and Z isomers), 2,3,3,3-tetrafluoropropene (HFO 1234yf), 1,2,3,3-tetrafluoropropene (HFO1234ye); trifluoropropenes such as 3,3,3-trifluoropropene (1243zf); tetrafluorobutenes such as HFO 1345; pentafluorobutene isomers such as HFO1354; hexafluorobutene isomers such as HFO1336; heptafluorobutene isomers such as HFO1327; heptafluoropentene isomers such as HFO1447; octafluoropentene isomers such as HFO1438; nonafluoropentene isomers such as HFO1429; HCFOs such as 1-chloro-3,3,3-trifluoropropene (HCFO-1233d), 2-chloro-3,3,3-trifluoropropene (HCFO-1233xf), HCFO1223, 1,2-dichloro-1,2-difluoroethene (E and Z isomers), 3,3-dichloro-3-fluoropropene, 2-chloro-1,1,1,4,4,4-hexafluorobutene-2 (E and Z isomers), 2-chloro-1,1,1,3,4,4,4-heptafluorobutene-2 (E and Z isomers). Particularly advantageous blowing agents in the pre-mixes of the present invention comprise unsaturated halogenated hydroolefins with normal boiling points less than about 60° C.

In one embodiment, the blowing agent comprises, consists essentially of, or consists of 1-chloro-3,3,3-trifluoropropene, E and/or Z HCFO-1233zd. A major or predominant portion of the HCFO-1233zd may be the trans isomer. For example, in various embodiments the weight ratio of trans and cis isomers of HFCO-1233zd present in the blowing agent used is 100:0 to 70:30; 100:0 to 90:10; or 100:0 to 97:3.

The halogenated hydroolefin blowing agents in the pre-mix of the present invention can be used alone or in combination with other blowing agents including but not limited to: (a) hydrofluorocarbons including but not limited to difluoromethane (HFC-32); 1,1,1,2,2-pentafluoroethane (HFC-125); 1,1,1-trifluoroethane (HFC143a); 1,1,2,2-tetrafluorothane (HFC-134); 1,1,1,2-tetrafluoroethane (HFC-134a); 1,1-difluoroethane (HFC-152a); 1,1,1,2,3,3,3-heptafluoropropane (HFC-227ea); 1,1,1,3,3-pentafluopropane (HFC-245fa); 1,1,1,3,3-pentafluorobutane (HFC-365mfc) and 1,1,1,2,2,3,4,5,5,5-decafluoropentane (HFC-4310mee), (b) hydrocarbons including but not limited to, pentane isomers and butane isomers, (c) hydrofluoroethers (HFE) such as, C₄F₉OCH₃ (HFE-7100), C₄F₉OC₂H₅ (HFE-7200), CF₃CF₂OCH₃ (HFE-245cb2), CF₃CH₂CHF₂ (HFE-245fa), CF₃CH₂OCF₃ (HFE-236fa), C₃F₇OCH₃ (HFE-7000), 2-trifluoromethyl-3-ethoxydodecofluorohexane (HFE-7500), 1,1,1,2,3-hexafluoro-4-(1,1,2,3,3,3-hexafluoropropoxy)-pentane (HFE-7600), 1,1,1,2,2,3,5,5,5-decafluoro-3-methoxy-4-(trifluoromethyl)pentane (HFE-7300), ethyl nonafluoroisobutyl ether/ethyl nonafluorobutyl ether (HFE-8200), CHF₂OCHF₂, CHF₂OCH₂F, CH₂FOCH₂F, CH₂FOCH₃, cyclo-CF₂CH₂CF₂O, cyclo-CF₂CF₂CH₂O, CHF₂CF₂CHF₂, CF₃CF₂OCH₂F, CHF₂OCHFCF₃, CHF₂OCF₂CHF₂, CH₂FOCF₂CHF₂, CF₃OCF₂CH₃, CHF₂CHFOCHF₂, CF₃OCHFCH₂F, CF₃CHFOCH₂F, CF₃OCH₂CHF₂, CHF₂OCH₂CF₃, CH₂FCF₂OCH₂F, CHF₂OCF₂CH₃, CHF₂CF₂OCH₃ (HFE₂₅₄ pc), CH₂FOCHFCH₂F, CHF₂CHFOCH₂F, CF₃OCHFCH₃, CF₃CHFOCH₃, CHF₂OCH₂CHF₂, CF₃OCH₂CH₂F, CF₃CH₂OCH₂F, CF₂HCF₂CF₂OCH₃, CF₃CHFCF₂OCH₃, CHF₂CF₂CF₂OCH₃, CHF₂CF₂CH₂OCHF₂, CF₃CF₂CH₂OCH₃, CHF₂CF₂OCH₂CH₃, (CF₃)₂CFOCH₃, (CF₃)₂CHOCHF₂, (CF₃)₂CHOCH₃, and mixture thereof; (d) C1 to C5 alcohols, C1 to C4 aldehydes, C1 to C4 ketones, C1 to C4 ethers and diethers; e) water; (f) carbon dioxide; and (g) trans-1,2-dichloroethylene.

Suitable polyols include any of the hydroxyl-functionalized oligomeric substances known in the thermoset foam art, including polyester polyols, polyether polyols, polyether/ester polyols and combinations thereof. Exemplary polyether polyols may, for example, be selected from the group consisting of propoxylated glycerin polyether polyols, propoxylated sucrose polyether polyols, propoxylated sorbitol polyether polyols, propoxylated amine polyether polyols, propoxylated Mannich polyether polyols, and combinations thereof. In one embodiment, the polyol pre-mix includes at least one polyether polyol having a functionality of 3 or 4 or more, optionally in combination with a polyester polyol and/or polyether polyol having a functionality of from about 1.9 to about 3. Aromatic polyester polyols may be utilized.

Exemplary suitable polyols include, but are not limited to: glycerin-based polyether polyols such as Carpol® GP-700, GP-725, GP-4000, GP-4520; amine-based polyether polyols such as Carpol® TEAP-265 and EDAP-770, Jeffol® AD-310; sucrose-based polyether polyols, such as Jeffol® SD-360, SG-361, and SD-522, Voranol® 490, Carpol® SPA-357; Mannich-based polyether polyols such as Jeffol® R-425X and R-470X; sorbitol-based polyether polyols such as Jeffol® S-490; and aromatic polyester polyols such as Terate® 2541 and 3510, Stepanpol® PS-2352, Terol® TR-925; as well as combinations thereof.

The pre-mixes of the present invention are further characterized by the presence of one or more cycloaliphatic epoxides. The addition of such cycloaliphatic epoxides was discovered to lead to improvements in the stability of a polyol pre-mix containing halogenated hydroolefin over time, as in extending the shelf-life of the pre-mix and enhancing the properties of the foam prepared from the pre-mix after the pre-mix has been stored for a period of time. The cycloaliphatic epoxides suitable for use in the present invention are organic compounds having at least one aliphatic ring, within which at least one epoxy group is present. That is, the two carbon atoms of such epoxy group are part of the aliphatic ring. These epoxy group carbon atoms may independently be substituted or unsubstituted. “Unsubstituted” means that the carbon atom bears a hydrogen atom, whereas “substituted” means the carbon atom bears a substituent other than a hydrogen atom. The cycloaliphatic epoxide may be unsubstituted, monosubstituted or disubstituted, with “unsubstituted” meaning that neither of the carbon atoms forming part of the epoxy groups bears a substituent other than hydrogen, “monosubstituted” meaning only one of the two carbon atoms forming part of the epoxy group bearing a substituent other than hydrogen and “disubstituted” meaning both carbon atoms forming part of the epoxy group bear a substituent other than hydrogen, wherein such substituents may be the same as or different from each other. Such substituent(s) may be, for example, an alkyl group, in particular a C1-C6 linear or branched alkyl group such as methyl. In a preferred embodiment, just one of the two carbon atoms is substituted. In a particularly preferred embodiment, suitable cycloaliphatic epoxides are those in which both carbon atoms which are part of the epoxy group of the cycloaliphatic epoxide are unsubstituted. Thus, the cycloaliphatic epoxide in such preferred embodiment comprises an unsubstituted epoxy moiety having the following structure:

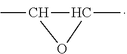

In a substituted cycloaliphatic epoxide, one or both (preferably, only one) of the hydrogen atoms in the epoxy group is replaced by a non-hydrogen substituent such as an alkyl group (e.g., methyl).

Cyclohexene oxide, corresponding to the following structure, is an example of an unsubstituted cycloaliphatic epoxide:

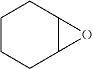

Alpha-pinene oxide, corresponding to the following structure, is an example of a monosubstituted cycloaliphatic epoxide:

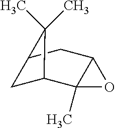

In one embodiment, the cycloaliphatic epoxide contains a single epoxy moiety, but in other embodiments two or more epoxy moieties are present in the cycloaliphatic epoxide. The cycloaliphatic epoxide contains at least one aliphatic ring; in certain embodiments, two or more aliphatic rings are present in the cycloaliphatic epoxide. If the cycloaliphatic epoxide contains a single aliphatic ring, that aliphatic ring may contain one, two or more epoxy groups. The two or more aliphatic rings may be separate or fused. If the cycloaliphatic epoxide contains a plurality of aliphatic rings, each of the aliphatic rings may contain one two or more epoxy groups; alternatively, one or more of the aliphatic rings does not contain any epoxy groups, provided that at least one aliphatic ring in the cycloaliphatic epoxide does contain at least one epoxy group. The aliphatic ring(s) may be saturated or unsaturated and may, in various embodiments of the invention contain five, six, seven, eight or more carbon atoms. Thus, the cycloaliphatic epoxide may contain a five- to eight-membered aliphatic ring. In one embodiment, the cycloaliphatic epoxide is saturated (i.e., does not contain any carbon-carbon double bonds). In another embodiment, the cycloaliphatic epoxide is unsaturated (i.e., contains one or more carbon-carbon double bonds, which may be part of an aliphatic ring or external to any aliphatic ring). The aliphatic ring(s) may be unsubstituted, or may be substituted with one, two or more substituents such as alkyl groups (e.g., methyl, ethyl. propyl), aryl groups (e.g., phenyl), halogens (e.g., F, Br, Cl), ether groups (e.g., methoxy, ethoxy), vinyl groups, ester groups and the like. Examples of suitable cycloaliphatic epoxides include, but are not limited to, cyclopentene oxide; cyclohexene oxide; cycloheptene oxide; cyclooctene oxide; norbornene oxide; dicyclopentadiene oxide; dicyclopentadiene dioxide; cyclic terpene oxides such as terpineol oxide, alpha-ionone oxide, limonene oxide, terpinene oxide, alpha-pinene oxide and menthadiene oxide; and combinations thereof.

Other suitable cycloaliphatic epoxides include compounds containing two aliphatic rings (in particular, two six-membered aliphatic rings), which may be either linked directly through a single bond or through a divalent linking moiety X. For example, the divalent linking moiety may be oxygen (Y=—O—), alkylene (e.g., Y=—CH₂—, —CH₂CH₂—, —CH₂CH₂CH₂—, —CH₂CH(CH₃)— or —C(CH₃)₂—), an ether-containing moiety (e.g., Y=—CH₂OCH₂—), or a carbonyl-containing moiety (e.g., Y=—C(═O)—). Specific illustrative examples of such cycloaliphatic epoxides are bis(3,4-epoxycyclohexyl) (where X is a single bond, also referred to as 3,4,3′,4′-diepoxybicyclohexyl), bis[(3,4-epoxycyclohexyl)ether] (where X is an oxygen atom), bis[(3,4-epoxycyclohexyl)methane] (where X is methylene, CH₂), 2,2-bis(3,4-epoxycyclohexyl)propane (where X is —C(CH₃)₂—) and the like and combinations thereof.

The cycloaliphatic epoxide(s) can be added in combination with the blowing agent(s) and/or amine catalyst(s) or can be added separately from the blowing agent(s) and/or amine catalyst(s) into the polyol pre-mix by means known in the art.

Generally speaking, the pre-mix includes an amount of cycloaliphatic epoxide sufficient to cause an increase in the shelf-life of the polyol pre-mix, as compared to the shelf-life of an analogous pre-mix that does not contain such a cycloaliphatic epoxide. The typical total amount of cycloaliphatic epoxide employed is from about 0.2 wt % to about 7 wt % of the polyol pre-mix; in one embodiment, cycloaliphatic epoxide comprises from about 0.3 wt % to about 5 wt % of the polyol pre-mix; in another embodiment, the polyol pre-mix is comprised of from 0.5 wt % to about 2 wt % of the polyol pre-mix.

The pre-mixes of the present invention further comprise one or more amine catalysts. Any of the amine catalysts known or used in the polyurethane foam art may be employed. Tertiary amine catalysts, including aliphatic tertiary amines in particular, are useful in the present invention, although primary and/or secondary amines and amines that contain one or more hydroxyl groups may also or alternatively be employed. Combinations of different types of amine catalysts may also be present in the pre-mix. Suitable catalysts include amine catalysts containing one, two or more amine groups per molecule. If two or more amine groups are present in a particular amine catalyst, they may be the same as or different from each other. For example, the amine catalyst may contain a plurality of amine groups, one or more of which is a tertiary amine group and one or more of which may be a primary or secondary amine group. In one embodiment, the amine catalyst contains only tertiary amine groups.

Exemplary amine catalysts include, but are not limited to: N,N-dimethylethanolamine (DMEA), N,N-dimethylcyclohexylamine (DMCHA), bis(N,N-dimethylaminoethyl)ether (BDMAFE), N,N,N′,N′,N″-pentamethyldiethylenetriamine (PMDETA), 1,4-diazadicyclo[2,2,2]octane (DABCO, also referred to as triethylene diamine), 2-(2-dimethylaminoethoxy)-ethanol (DMAFE), 2-((2-dimethylaminoethoxy)-ethyl methyl-amino)ethanol, 1-(bis(3-dimethylamino)-propyl)amino-2-propanol, N,N′,N″-tris(3-dimethylamino-propyl)hexahydrotriazine, dimorpholinodiethylether (DMDEE), N.N-dimethylbenzylamine, N,N,N′,N″,N″-pentaamethyldipropylenetriamine, N,N′-diethylpiperazine. Sterically hindered primary, secondary or tertiary amines are useful, for example, dicyclohexylmethylamine, ethyldiisopropylamine, dimethylcyclohexylamine, dimethylisopropylamine, methylisopropylbenzylamine, methylcyclopentylbenzylamine, isopropyl-sec-butyl-trifluoroethylamine, diethyl-α-phenyethyl)amine, tri-n-propylamine, dicyclohexylamine, t-butylisopropylamine, di-t-butylamine, cyclohexyl-t-butylamine, de-sec-butylamine, dicyclopentylamine, di-α-trifluoromethylethyl)amine, di-(α-phenylethyl)amine, triphenylmethylamine, and 1,1,-diethyl-n-propylamine. Other sterically hindered amines include morpholines, imidazoles, ether containing compounds such as dimorpholinodiethylether, N-ethylmorpholine, N-methylmorpholine, bis(dimethylaminoethyl)ether, imidizole, nomethylimidazole, 1,2-dimethylimidazole, dimorpholinodimethylether, N,N,N′,N′,N″,N″-pentamethyldiethylenetriamine, N,N,N′,N′,N″,N″-pentaethyldiethylenetriamine, N,N,N′,N′,N″,N″-pentamethyldipropylenetriamine, bis(diethylaminoethyl)ether, bis(dimethylaminopropyl)ether, or combinations thereof.

The use level of amine catalyst is typically in an amount of from about 0.1 to about 5 wt % of the polyol pre-mix, for example from about 0.5 to about 4 wt %.

The pre-mixes of the present invention are capable of forming foams having a generally cellular structure, in particular after being combined with components (such as isocyanates) reactive with the hydroxyl groups of the polyol(s) to thereby form a thermoset. Examples of thermosetting compositions which may be prepared using the pre-mixes of the present invention include polyurethane and polyisocyanurate foam compositions, and also phenolic foam compositions preferably low-density foams, flexible or rigid.

The invention also relates to foam, and preferably closed cell foam, prepared from a pre-mix in accordance with the description provided herein.

In certain embodiments of the invention, the B-side polyol pre-mix can include (in addition to the previously described blowing agent(s), polyol(s) and amine catalyst(s)) silicone or non-silicone based surfactants, non-amine based catalysts, flame retardants/suppressors, acid scavengers, radical scavengers, fillers, water and other necessary or desirable stabilizers/inhibitors as well as other additives conventional in the thermoset foam art.

Exemplary non-amine catalysts include organometallic compounds containing bismuth, lead, tin, antimony, cadmium, cobalt, iron, thorium, aluminum, mercury, zinc, nickel, cerium, molybdenum, titanium, vanadium, copper, manganese, zirconium, magnesium, calcium, sodium, potassium, lithium or combination thereof such as stannous octoate, dibutyltin dilaurate (DGTDL), dibutyltin mercaptide, phenylmercuric propionate, lead octoate, potassium acetate/octoate, magnesium acetate, titanyl oxalate, potassium titanyl oxalate, quaternary ammonium formates, ferric acetylacetonate and combinations thereof.

The use level of non-amine catalyst is typically in an amount of from about 0.1 ppm to about 6.00 wt % of the polyol pre-mix, for example from about 0.5 ppm to 4 wt % or from about 1 ppm to 2 wt %.

Exemplary surfactants include, but are not limited to, silicone surfactants, e.g., polysiloxane polyoxyalkylene block co-polymers such as B8404, B8407, B8409, B8462 and B8465 available from Goldschmidt; DC-193, DC-197, DC-5582, and DC-5598 available from Air Products; and L-5130, L5180, L-5340, L-5440, L-6100, L-6900, L-6980, and L6988 available from Momentive. Exemplary non-silicone surfactants include salts of sulfonic acids, alkali metal salts of fatty acids, ammonium salts of fatty acids, oleic acid, stearic acid, dodecylbenzenedisulfonic acid, dinaphthylmethanedisulfonic acid, ricinoleic acid, oxyethylated alkylphenols, oxyethylated fatty alcohols, paraffin oils, castor oil esters, ricinoleic acid esters, Turkey red oil, groundnut oil, paraffin fatty alcohols, or combination thereof. Typically, use levels of surfactants are from about 0.4 to about 6 wt % of the polyol pre-mix, for example from about 0.8 to about 4.5 wt % or from about 1 to about 3 wt %.

Exemplary flame retardants include trichloropropyl phosphate (TCPP), triethyl phosphate (TEP), diethyl ethyl phosphate (DEEP), diethyl bis(2-hydroxyethyl)amino methyl phosphonate, brominated anhydride based ester, dibromoneopentyl glycol, brominated polyether polyol, melamine, ammonium polyphosphate, aluminum trihydrate (ATH), tris(1,3-dichloroisopropyl)phosphate, tri)-2-chlororthyl)phosphate, tri(2-chloroisopropyl)phosphate, chloroalkyl phosphate/oligomeric phosphonate, oligomeric chloroalkyl phosphate, brominated flame retardant based on pentabromo diphenyl ether, dimethyl methyl phosphonate, diethyl N,N bis(2-hydroxyethyl)amino methyl phosphonate, oligomeric phosphonate, and derivatives thereof.

In certain embodiments, acid scavengers, radical scavengers, and/or other types of stabilizers/inhibitors are included in the pre-mix. Exemplary stabilizers/inhibitors include epoxides other than the cycloaliphatic epoxides defined herein; cyclic terpenes such as dl-limonene, 1-limonene and d-limonene; nitromethane; diethylhydroxyl amine; alpha methylstyrene; isoprene; p-methoxyphenol; m-methoxyphenol; hydrazines; 2,6-di-t-butyl phenol; hydroquinone; organic acids such as carboxylic acid, dicarboxylic acid, phosphonic acid, sulfonic acid, sulfamic acid, hydroxamic acid, formic acid, acetic acid, propionic acid, butyric acid, caproic acid, isocaprotic acid, 2-ethylhexanoic acid, caprylic acid, cyanoacetic acid, pyruvic acid, benzoic acid, oxalic acid, malonic acid, succinic acid, adipic acid, azelaic acid, trifluoroacetic acid, methanesulfonic acid, or benzenesulfonic acid; esters, including esters of the aforementioned acids, such as methyl formate, ethyl formate, methyl acetate, isopropyl formate, isobutyl formate, isoamyl formate, methyl benzoate, benzyl formate or ethyl acetate; and combinations thereof. Other additives such as adhesion promoters, anti-static agents, antioxidants, fillers, hydrolysis agents, lubricants, anti-microbial agents, pigments, viscosity modifiers, UV resistance agents may also be included in the pre-mix. Examples of these additives include: sterically hindered phenols; diphenylamines; benzofuranone derivatives; butylated hydroxytoluene (BHT); calcium carbonate; barium sulphate; glass fibers; carbon fibers; micro-spheres; silicas; melamine; carbon black; waxes and soaps; organometallic derivatives of antimony, copper, and arsenic; titanium dioxide; chromium oxide; iron oxide; glycol ethers; dimethyl AGS esters; propylene carbonate; and benzophenone and benzotriazole compounds.

The preparation of polyurethane or polyisocyanurate foams using the compositions described herein may follow any of the methods well known in the art can be employed, see Saunders and Frisch, Volumes I and II Polyurethanes Chemistry and technology, 1962, John Wiley and Sons, New York, N.Y. or Gum, Reese, Ulrich, Reaction Polymers, 1992, Oxford University Press, New York, N.Y. or Klempner and Sendijarevic, Polymeric Foams and Foam Technology, 2004, Hanser Gardner Publications, Cincinnati, Ohio. In general, polyurethane or polyisocyanurate foams are prepared by combining an isocyanate, the polyol pre-mix composition, and other materials such as optional flame retardants, colorants, or other additives. These foams can be rigid, flexible, or semi-rigid, and can have a closed cell structure, an open cell structure or a mixture of open and closed cells.

It is convenient in many applications to provide the components for polyurethane or polyisocyanurate foams in pre-blended formulations. Most typically, the foam formulation is pre-blended into two components. The isocyanate and optionally other isocyanate compatible raw materials comprise the first component, commonly referred to as the “A-” side component. The polyol mixture composition, including polyol(s), surfactant(s), catalyst(s), blowing agent(s), and optional other ingredients comprise the second component, commonly referred to as the “B-” side component. In any given application, the “B-” side component may not contain all the above listed components, for example some formulations omit the flame retardant if that characteristic is not a required foam property. Accordingly, polyurethane or polyisocyanurate foams are readily prepared by bringing together the A- and B-side components either by hand mix for small preparations and, preferably, machine mix techniques to form blocks, slabs, laminates, pour-in-place panels and other items, spray applied foams, froths, and the like. Optionally, other ingredients such as fire retardants, colorants, auxiliary blowing agents, water, and even other polyols can be added as a stream to the mix head or reaction site. Most conveniently, however, they are all incorporated into one B-side component as described above. In some circumstances, A and B can be formulated and mixed into one component in which water is removed. This is typical, for example, for a spray-foam canister containing a one-component foam mixture for easy application.

A foamable composition suitable for forming a polyurethane or polyisocyanurate foam may be formed by reacting an organic polyisocyanate (i.e., organic compounds containing two or more isocyanate groups per molecule) and the polyol pre-mix composition described above. Any organic polyisocyanate can be employed in polyurethane or polyisocyanurate foam synthesis inclusive of aliphatic and aromatic polyisocyanates. Suitable organic polyisocyanates include aliphatic, cycloaliphatic, araliphatic, aromatic, and heterocyclic polyisocyanates which are well known in the field of polyurethane chemistry.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Comparative Examples 1 and 2

The formulations tested each had an Iso Index of 114 and contained Rubinate® M, a polymeric methylene diphenyl diisocyanate (MDI) available from Huntsman; Voranol® RN 490 and CP 450 polyols from Dow Chemical; and Stepanpol® PS 2412 polyol from Stephan. B 8465 is a surfactant from Evonik Industries. Polycat® 8 and 5 (pentamethyldiethylenetriamine, PMDETA) are available from Air Products. Table 1 summarizes the properties of the formulations tested. The A-side (MDI) and B-side (mixture of the polyol, surfactant, catalysts, blowing agent, and additives) were mixed with a hand mixer and dispensed into a container to form a free rise foam. When making a free rise foam, the dispensed material was allowed to expand in an open container.

TABLE 1
Formulation 1 using HFC365/227 and 1,2-Epoxybutane

wt % B-side

| | Comparative | Comparative |
|---|---|---|
| Formulation | Example 1 | Example 2 |
| Voranol ® RN 490 | 42.04 | 41.54 |
| Voranol ® CP 450 | 25.23 | 25.23 |
| Stepanpol ® PS 2412 | 16.82 | 16.82 |
| B 8465 | 1.65 | 1.65 |
| PolyCat ® 5 | 0.26 | 0.26 |
| PolyCat ® 8 | 0.82 | 0.82 |
| Water | 1.82 | 1.82 |
| 1,2-Epoxybutane | 0.00 | 0.50 |
| HFC365/227 (87/13) | 11.35 | 11.35 |
| Total | 100.00 | 100.00 |

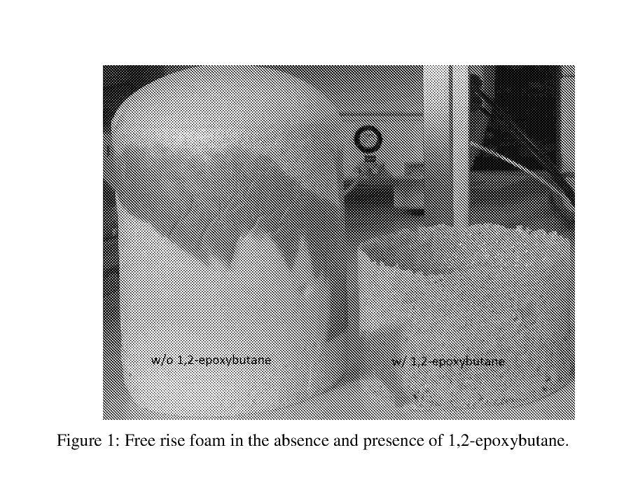

FIG. 1 shows that when using a B-side blend without 1,2-epoxybutane, foam is formed normally (in the left of FIG. 1), while in the presence of 1,2-epoxybutane, foam cannot be made as expected (in the right of FIG. 1).

TABLE 2

| Reactivity | Comparative Example 1 | Comparative Example 2 |
|---|---|---|
| Cream time (s) | 10 | no foam |
| Gel time (s) | 38 | no foam |
| Tack free time (s) | 60 | no foam |

### Comparative Examples 3 and 4

A formula very similar to that of Comparative Examples 1 and 2 was used, but the blowing agent was replaced by trans-1-chloro-3,3,3-trifluoropropene. The results obtained were similar to those shown in FIG. 1.

### Example 1

The following components, as listed in Table 3, were used: Rubinate® M, a polymeric methylene diphenyl diisocyanate (pMDI), Jeffol® polyols and Jeffcat® catalysts are available from Huntsman; Jeffol® R-425-X, a polyol from Huntsman; Voranol® 490, a polyol from Dow; Stepanpol® PS-2352, a polyol from Stepan Company; Tegostab® B8465, a surfactant available from Evonik-Degussa; Polycat® catalysts from Air Products; tris-(chloroisopropyl) phosphate (TCPP), a flame retardant, from ICL-IP America. Cyclohexene oxide was purchased from Aldrich Chemicals. The formulations tested all had an Iso Index of approximately 114.

TABLE 3
Formulation using trans-1233zd and cyclohexene oxide

wt % B-side

| Formulation | Example 1 | Example 2 |
|---|---|---|
| Voranol ® 490 | 37.21 | 36.67 |
| Jeffol ® R-425-X | 22.50 | 22.17 |
| Stepanpol ® PS 2352 | 15.13 | 14.91 |
| Tegostab ® B 8465 | 1.50 | 1.48 |
| TCPP | 4.98 | 4.90 |
| PolyCat ® 5 | 0.28 | 0.28 |
| PolyCat ® 8 | 0.92 | 0.92 |
| Water | 1.48 | 1.46 |
| Cyclohexene oxide | 0 | 1.20 |
| Trans-1233zd | 16.00 | 16.00 |
| Total | 100.00 | 100.00 |

Using both formulations, normal foams were obtained with similar quality and reactivity. The reactivities of the formulations are shown in Table 4.

TABLE 4

| Reactivity | Example 1 | Example 2 |
|---|---|---|
| Cream time (s) | 10 | 11 |
| Gel time (s) | 38 | 38 |
| Tack free time (s) | 60 | 66 |

Table 4 shows that using cyclohexene oxide, foams with similar quality and reactivity can surprisingly be made.

### Example 3 and 4

The formulations of Examples 1 and 2 were aged at 50° C. for 7 and 14 days respectively. Hand-mixed foams were made; their reactivities were measured and are summarized in Table 5.

TABLE 5

| | Example 3 | | Example 4 | |
|---|---|---|---|---|
| Reactivity change (%) | 7 days | 14 days | 7 days | 14 days |
| Cream time | +70 | +110 | +36 | +64 |
| Gel time | +42 | +58 | +32 | NA* |
| Tack free time | +42 | +68 | +21 | NA* |

*Foam quality was sufficient to measure

With addition of cyclohexene oxide, an improvement of aged reactivity was observed (i.e., the formulation containing cyclohexene oxide exhibited greater stability on aging than the formulation without cyclohexene oxide).

### Examples 5 and 6

¹H NMR experiments were performed at 25° C. using a Bruker Avance III 500 (11.7 T) equipped with a 5 mm ¹H/¹⁹F/¹³C TXO probe. Aliquots of bulk phase samples were taken from chilled test tubes and diluted in 0.5-1 mL CDCl₃ to make 1-5% (v/v) concentration. A quantitative method was established, to measure the extent of acidification of amine catalysts resulted from aging, by measuring the deshielding (downfield shift) of —NCH₃ peak of PC8 in ¹H NMR, in comparison to the fresh blend, as listed in the last column of Table 1. A peak shift less than 0.01 ppm (5 Hz for 500 MHz NMR) is considered negligible. Peaks were referred to the main signal of —CH₂Cl (1.7 ppm) of TCPP (flame retardant), therefore, peak shift was corrected accordingly.

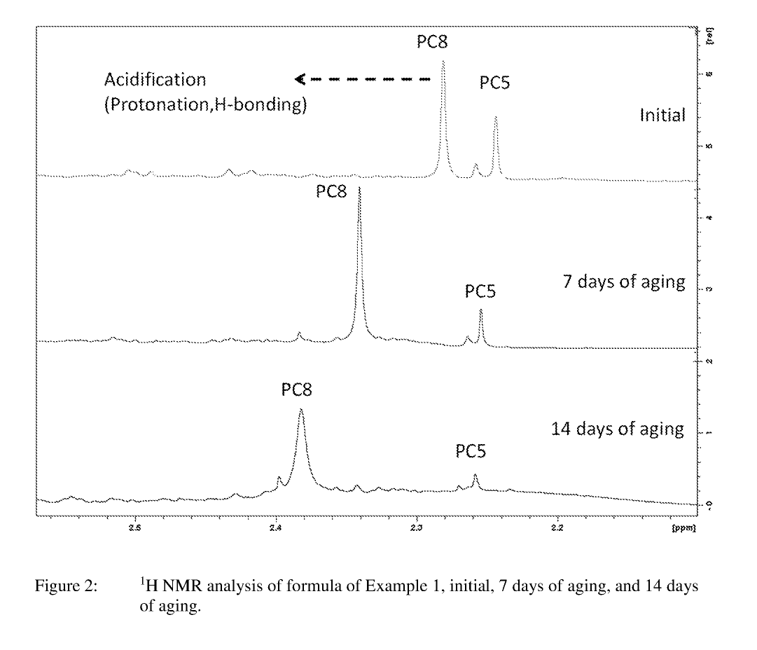

FIG. 2 shows that in the absence of cyclohexene oxide, PolyCat® 8 (PC8) was progressively acidified as it was aged.

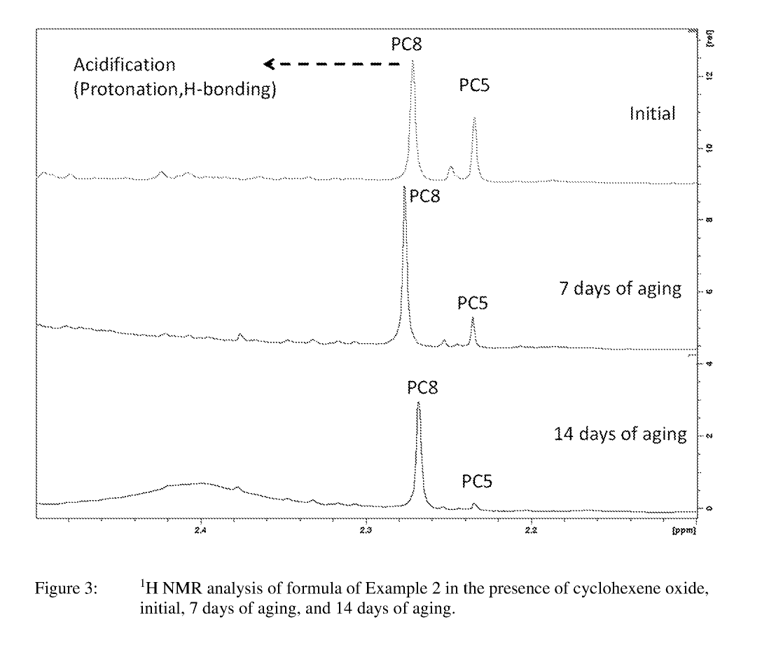

FIG. 3 shows that in the presence of cyclohexene oxide, the position of PolyCat® 8 (PC8) was relatively unchanged, indicating acidification was minimized.

1. A polyol pre-mix comprising:
a) at least one blowing agent, including at least one halogenated hydroolefin blowing agent;
b) at least one polyol;
c) at least one amine catalyst; and
d) at least one cycloaliphatic epoxide which contains at least one epoxy group consisting of an oxygen atom and two carbon atoms which are part of an aliphatic ring.

2. The polyol pre-mix of claim 1, wherein the at least one cycloaliphatic epoxide is essentially non-reactive with the at least one amine catalyst in the polyol pre-mix at 25° C. for a period of at least 6 months.

3. The polyol pre-mix of claim 1, wherein a substituent other than hydrogen is bonded to one of the two carbon atoms which are part of the aliphatic ring.

4. The polyol pre-mix of claim 1, wherein neither of the carbon atoms which are part of the aliphatic ring is substituted with a substituent other than hydrogen.

5. The polyol pre-mix of claim 1, wherein the at least one halogenated hydroolefin blowing agent is selected from the group consisting of hydrofluoroolefins, hydrochlorofluoroolefins, and combinations thereof.

6. The polyol pre-mix of claim 1, wherein the at least one halogenated olefin blowing agent includes HFCO-1233zd.

7. The polyol pre-mix of claim 1, additionally comprising at least one surfactant.

8. The polyol pre-mix of claim 1, comprising at least one amine catalyst selected from the group consisting of tertiary amines.

9. The polyol premix of claim 1, comprising from about 0.1 to about 5% by weight amine catalyst.

10. The polyol pre-mix of claim 1, wherein the aliphatic ring is a five- to eight-membered ring.

11. The polyol pre-mix of claim 1, wherein the at least one cycloaliphatic epoxide includes at least one cycloaliphatic epoxide selected from the group consisting of cyclopentene oxide, cyclohexene oxide, cycloheptene oxide, cyclooctene oxide, norbornene oxide, terpineol oxide, alpha-ionone oxide, limonene oxide, terpinene oxide, alpha-pinene oxide, menthadiene oxide, dicyclopentadiene oxide, and dicyclopentadiene dioxide.

12. The polyol pre-mix of claim 1, wherein the polyol pre-mix is comprised of from about 0.2 wt % to about 7 wt % cycloaliphatic epoxide.

13. The polyol pre-mix of claim 1, wherein the polyol pre-mix is comprised of from about 0.5 wt % to about 2 wt % cycloaliphatic epoxide.

14. The polyol pre-mix of claim 1, wherein the at least one polyol includes at least one polyester polyol.

15. The polyol premix of claim 1, wherein the at least one polyol includes at least one polyester polyol and at least one polyether polyol.

16. The polyol premix of claim 16, wherein the at least one polyether polyol includes at least one polyether polyol selected from the group consisting of propoxylated glycerin polyether polyols, propoxylated sucrose polyether polyols, propoxylated sorbitol polyether polyols, propoxylated amine polyether polyols, propoxylated Mannich polyether polyols, and combinations thereof.

17. The polyol pre-mix of claim 14, wherein the at least one polyester polyol includes at least one aromatic polyester polyol.

18. The polyol pre-mix of claim 1, wherein the at least one polyol includes at least one polyether polyol having a functionality of 3 or more.

19. A method of making a thermoset foam, comprising combining a polyol pre-mix in accordance with claim 1 with at least one substance reactive with the at least one polyol.

20. The method of claim 19, wherein the at least one substance reactive with the at least one polyol includes at least one polyisocyanate.

21. A method of stabilizing a polyol pre-mix comprised of at least one polyol, at least one amine catalyst and at least one halogenated hydroolefin blowing agent, wherein the method comprises incorporating into the polyol pre-mix at least one cycloaliphatic epoxide which contains at least one epoxy group consisting of an oxygen atom and two carbon atoms which are part of an aliphatic ring.
